(19) United States
(12) Patent Application Publication
(10) Pub. No.: US 2005/0154611 A1
(43) Pub. Date: Jul. 14, 2005

(54) Product support method for industrial processes

(75) Inventors: Chester Beeler, Cornelius, NC (US); Brian Gore, Denver, NC (US); Chris Brittain, Davidson, NC (US)

Correspondence Address: LERNER AND GREENBERG, PA, P O BOX 2480, HOLLYWOOD, FL, 33022-2480, US

(73) Assignee: SGL Carbon, AG

(21) Appl. No.: 11/036,676

(22) Filed: Jan. 13, 2005

Related U.S. Application Data
(60) Provisional application No. 60/536,023, filed on Jan. 13, 2004.

(51) Int. Cl. G06F 17/60

(52) U.S. Cl. 705/1; 705/9

(57) ABSTRACT

A supplier of products that are useful in an industrial process provides enhanced services associated with the product. The support method applies in a business relationship between a supplier and a consumer, wherein the consumer uses the products in the industrial process. A variety of parameters of the industrial process are monitored and items of performance information concerning the products used in the industrial process are acquired. Corresponding data are stored in a memory device at the consumer's location. The data are sporadically transmitted to the supplier, where the data are stored in a centralized database. There, the data are processed and reports are generated concerning the consumer's industrial process and the performance of the products in the industrial process. Real-time “on call” engineering services may be provided by the supplier on the basis of the data and/or reports for the consumer's use can be generated.

### CROSS-REFERENCE TO RELATED APPLICATION

This application claims the benefit, under 35 U.S.C. § 119(e), of copening provisional application 60/536,023, filed Jan. 13, 2004. The prior application is herewith incorporated by reference in its entirety.

### BACKGROUND OF THE INVENTION

Field of the Invention

The invention relates to a method and a system for monitoring power consumption, wear behavior, and efficiency patterns in plant processes and to a method of providing associated reports.

In many power-consuming processes, the efficient utilization of electricity is a primary goal. Energy costs and power interruptions can have an existentially detrimental impact on a corresponding business in that energy costs directly relate to profits. The immediate recognition of problem issues in the context and early rectification may prevent catastrophic productivity interruptions or inefficient power consumption.

By way of example, electric arc furnaces used for melting steel scrap, are extremely large consumers of electrical energy. Furthermore, the graphite electrodes used to conduct the arc are consumed during process cycling after a set number of heat cycles and they must be replaced from time to time. A variety of parameters are of interest to the plant operator, including instantaneous current consumption, voltage readings, power factor, system reactance, electrode consumption, and the like.

Plant operators monitor their power-consuming and material-consuming systems in a variety of ways. Various levels of sophistication in the monitoring detail can be found, depending on the individual operator. Due to competitive constraints, the different operators do not typically exchange process data among each other. Overview data concerning entire industry segments as well as historical trending in power consumption and wear are therefore hardly available.

### SUMMARY OF THE INVENTION

It is accordingly an object of the invention to provide a product support method which overcomes the above-mentioned disadvantages of the heretofore-known devices and methods of this general type and which allows a supplier of products to provide an elevated level of service as a value addition to his products and to aid with trending and real-time reports concerning the consumer's industrial process.

With the foregoing and other objects in view there is provided, in accordance with the invention, a product support method in a business relationship between a supplier and a consumer, wherein the supplier supplies products to the consumer and the consumer uses the products in an industrial process. The novel method comprises the following steps:

under control of a system established at the consumer's location:

monitoring the industrial process and acquiring items of performance information concerning the products used in the industrial process;

storing data with the items of performance information in a memory device;

under control of the system established at the consumer's location or a system established at the supplier's location:

initiating a connection and transferring data with the performance information from the memory device to a database maintained at the supplier's location;

under control of the system established at the supplier's location:

processing the data and generating a report concerning the consumer's industrial process and the performance of the products in the industrial process.

In accordance with an added feature of the invention, the products are wear items and the performance information includes information about a rate of wear of the products. By way of example, the step of generating a report comprises predicting when a supply of products will be exhausted by the consumer and prompting the consumer for a delivery order or initiating a further delivery of products.

In accordance with a preferred embodiment of the invention, the industrial process is a smelting process with an electric arc furnace and the products are electrodes. The monitoring step in that case comprises measuring and recording a voltage at the electrodes and a current consumed by the electrical arc furnace. The method further comprises recording real-time data and storing the real-time data spanning a given time period (e.g., in the order of several hours) in the memory device, and pre-processing the real-time data by averaging the data over extended time periods.

In accordance with another feature of the invention, the given time period is set to between 1 and 10 hours and the data are transferred from the consumer's location to the supplier's location approximately once a day. For example, the data transfer may be scheduled for midnight of every week day.

In accordance with a further feature of the invention, the above-noted consumer is one of a plurality of consumers commonly connected to the supplier. In that case, the data processing step comprises establishing comparative information and benchmarking data for use by each of the plurality of consumers.

In accordance with another exemplary embodiment of the invention, the industrial process is an aluminum electrolysis process with Hall-Heroult electrolysis cells, and the products are cathode blocks. Here, the monitoring step comprises repeatedly checking the cathode blocks for a degree of erosion requiring imminent replacement. Similarly, the method can be adapted to the monitoring of blast furnaces. In that case, the process monitors the erosion of carbon or graphite furnace lining blocks.

With the above and other objects in view there is also provided, in accordance with the invention, a product support method, which comprises:

under control of a system established at the consumer's location:

monitoring the industrial process and acquiring items of performance information concerning the products being used in the industrial process;

storing data with the items of performance information in a memory device;

upon detecting abnormal or catastrophic behavior in the industrial process, initiating a trouble-shooting session by reporting the abnormal or catastrophic behavior to the supplier;

under control of the consumer or under control of the supplier:

initiating a connection and downloading data with the performance information from the memory device;

under control of the supplier:

processing the data and generating a report concerning the consumer's industrial process and the performance of the products in the industrial process.

This, therefore, provides for a real-time system that allows immediate reaction in the case of abnormal behavior or in the case of a failure of the system.

A variety of advantages are gained by implementing the novel system according to the invention. For example, the onsite electronics are kept to a minimum, which is advantageous in typically very harsh environments found in many industrial plants. Accordingly, problems associated with crashing computers or customers accidentally wrong programming or shutting down important monitoring system computers is averted. A multitude of installations can be remotely monitored and a considerably improved level of uniformity is obtained. Thus, many performance indicators can be benchmarked.

Furthermore, the supplier obtains valuable data feedback concerning the behavior of its product. Customer data can be used not only to provide customer reports and comparative benchmarks, but also technical feedback.

The remote monitoring and analyzing allows quicker response times to customer requests and customer problems. Remote analysis can be turned into valuable reports and provided to the customer.

As noted above, the prior art did not allow for data exchange, overview data development, and historical trending in power consumption. Such overview data, however, could iteratively aid individual operators to improve their efficiency. Such monitoring of data and support is made possible and aided by the novel system according to the invention. It will be understood that such information is handled with the highest degree of confidentiality and will not be disseminated between one consumer and a competing entity. Any data exchange between operators will be entirely anonymous, even on the input side of the database that is run by the supplier.

Other features which are considered as characteristic for the invention are set forth in the appended claims.

Although the invention is illustrated and described herein as embodied in a product support method for industrial processes, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWING

FIG. 1 is a diagrammatic overview of a distributed system according to the invention;

FIG. 2 is a diagram showing several geographically distributed processing plants and a central service provider hub according to the invention; and

FIG. 3 is a view similar to that of FIG. 1 of the system according to the invention illustrating an information flow during a real-time monitoring and trouble-shooting session.

### DESCRIPTION OF THE PREFERRED EMBODIMENTS

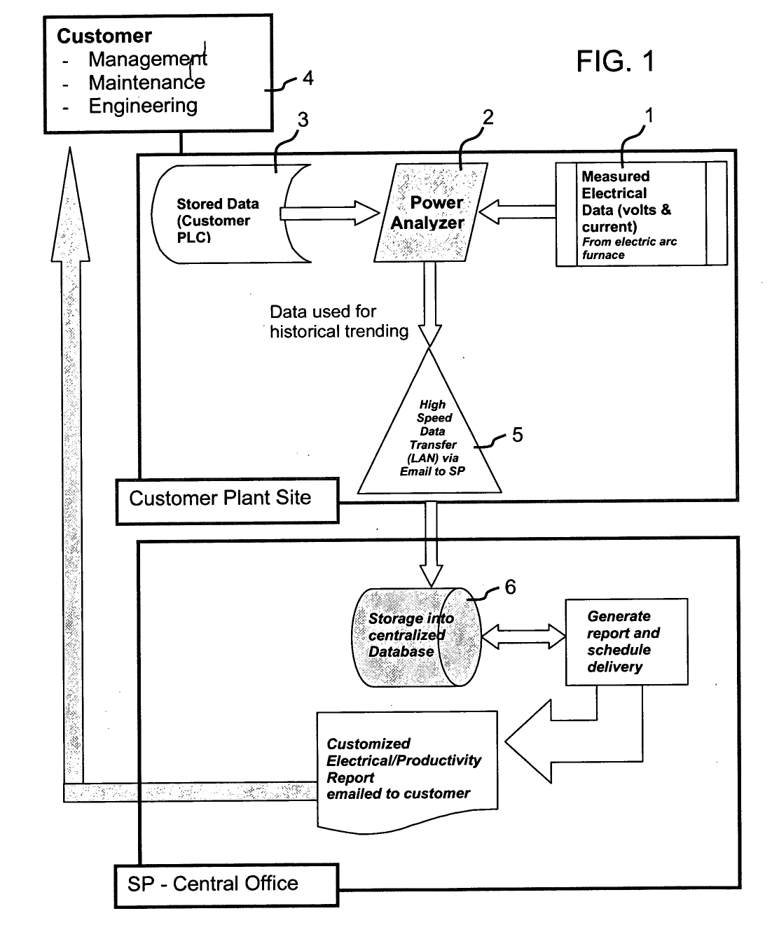

Referring now to the figures of the drawing in detail and first, particularly, to FIG. 1 thereof, the system includes a customer—illustrated in the upper half of the figure—and a service provider SP—illustrated in the lower half of the figure.

The customer side process plant is a steel smelting operation with a three-phase electric arc furnace 1. Pertinent signals of the furnace 1, namely, a voltage value and a current value, are supplied to a power analyzer 2. The power analyzer 2 also receives signals from the customer's database 3, which provides customer PLC (programmable logic controller, power level controller) signals. By way of example, these signals may include “end of heat” and “end of batch” signals, information on which voltage tap (i.e., which phase) they are on, the amount of carbon in the batch, the amount of oxygen, and the like.

The customer's head office 4 may be on-site or it may be in a remote location from the processing furnace 1. Various on-site displays and real-time reports may be installed at the head office, each on the basis of power analyzer 2 output. By way of example, such a monitoring system may include a display indicating arc stability during heats.

The power analyzer 2, in an exemplary implementation, is an ION 7500 Digital Power Meter (Metering and Control Device), available commercially from Power Measurement Co. (details at http://www.pwrm.com/products/ION7500/). Here, the power analyzer 2 is used with 1 MB or 3 MB internal storage, and provided with a dial-up modem and an Ethernet card 10 base-T to allow the analyzer 2 to hooked up to a local network LAN and to provide for e-mail capabilities.

The power analyzer 2 can be set for a variety of reading frequencies. That is, the pertinent values such as the voltage at each voltage tap (each carrying a respective phase of one electrode) may be read and recorded every 0.5 seconds or once a second. The values are stored in digital form. Typically, real-time data may be retained for a given length of time, depending on the available bandwidth and the number of data points that are to be stored, before they are combined in trending data. Here, the power analyzer is set to scan the available data at 1 Hz (once a second) and then to retain the real-time information for a period of 4 hours. Should it be necessary for the SP to trouble-shoot the plant operation—for example, in the case of a catastrophic failure of one or more of the phases—then 4 hours of historical data is typically sufficient.

The power analyzer 2 is set to transfer its collected data out to the SP facility by e-mail at scheduled intervals, such as, for example, once a day. The necessary transfer software is available from Power Management under the name metermail (cf. http://www.pwrm.com/products/metermail/). The real-time data may or may not be transferred to the SP along with the pre-processed data.

It will be understood from the foregoing that the communications interface 5 allows for a variety of data transfer options. These include LAN-to-mail, direct dial-in and dial-up, Internet log-in, FTP downloads, or VPN (virtual private network), to name just a few. It will be understood that all communication and data exchange is subjected to the highest security control in order to avoid cross-dissemination and unacceptable disclosure of confidential data. Electronic communication may be suitably encoded, for example with private/public key pairs, and data transfer is effected via secure communications channels.

What is important in the context of the invention, is the collection of the data in a centralized database 6. The data may be stored in “raw” format (i.e., pure real-time information), in averaged format, or in historical trending data. From the information stored in the database 6, it is possible for the service provider SP to generate a variety of reports. For example, it is possible to generate a customized electrical behavior and productivity report to be emailed to the customer at scheduled times. In an exemplary implementation, for instance, a full set of productivity reports together with predefined key performance indicators (KPIs) covering the previous week's production are sent to the customer every Monday morning.

Additional benefit may be had, however, from the available data. The service provider, in the example, is also the supplier of wear items. Here, the SP is the producer of the carbon electrodes for the electric arc furnace. From the electrical data, the SP deduces the status of the electrodes and is therefore able to predict when the customer requires additional electrodes. On confirmation, the SP may schedule a delivery of additional electrodes. The system may be integrated as a value-added service at a relatively small cost to the SP. Furthermore, of course, the SP also gains important technical information and quality assurance information with respect to their carbon electrodes.

It will be understood that the system according to the invention is applicable to a variety of environments. By way of example, the customer plant may be an electrolysis operation and the SP may be the supplier of graphite cathode blocks for the electrolysis cells. Cathode blocks, of course, are wear items. The graphite cathodes may be provided with integrated tracer materials which, as the block erodes to a certain wear level, are released for detection by the operator. Corresponding wear detection mechanisms are described, for example, in a recent application filed by SGL Carbon of Germany, the corporate assignee of this invention. The analyzer 2 (here not necessarily a “power” analyzer, but a corresponding process analyzer with chemical and/or electrical detection capabilities) may then provide the necessary signals which allow the SP to schedule deliveries of cathode blocks, because the SP also knows the number of remaining cathode blocks in the customer's inventory.

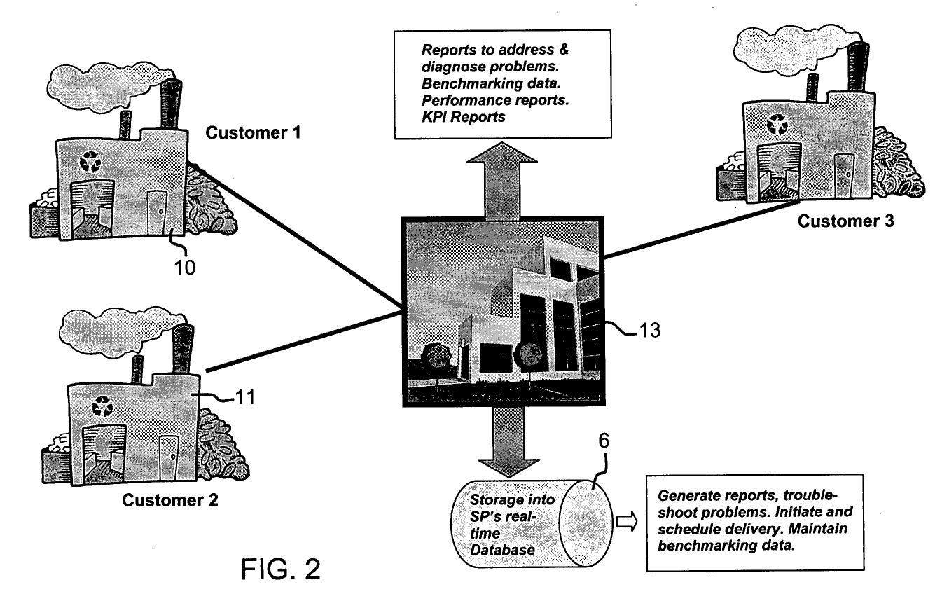

FIG. 2 illustrates a distributed system with a plurality of customers 10, 11, 12 and a centralized SP database 13. The system here does not only provide for the individualized reports based on the customer data, but it also provides for comparative information. The customers 10, 11, 12 may be different plants belonging to a single owner, or they may be entirely separate entities. While data cross-exchange in the former situation is typically acceptable, any such exchange is carefully avoided in the latter case. Nevertheless, similar production and processing facilities are subject to similar data and KPI needs. The centralized database, therefore, may be used for benchmarking purposes and similar comparative services. The exchange of non-privileged and non-sensitive performance data, even between competitors, leads to more efficient processes. Such optimization efforts are especially desirable in the context of high electrical energy consumers.

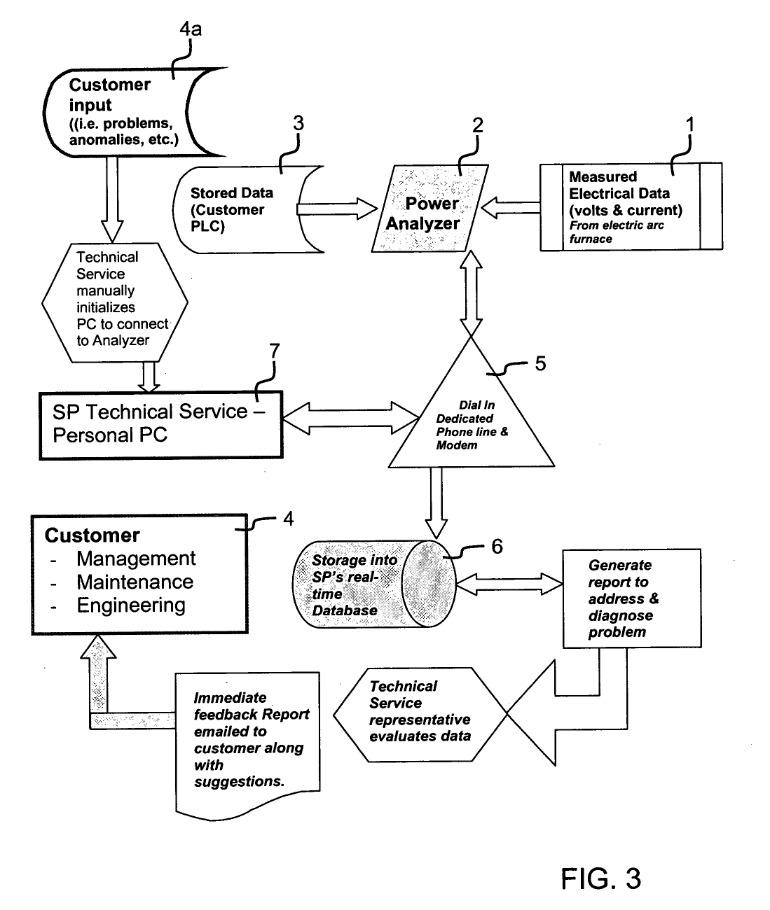

FIG. 3 refers back to the system as is described in FIG. 1. Here, there is a requirement for real-time trouble-shooting. The customer 4 has just found a problem or an unexplained anomaly in the internal power system. The customer initiates a trouble-shooting session by inputting the required information at 4a. The SP's service technician, either onsite at the customer location or off-site at the SP's central location, then connects his programmed computer or PC 7 to the power analyzer 2 in order to request a download of the data stored on the analyzer 2. As noted above, the data includes raw real-time data with a historical content of several hours and pre-processed data. The PC 7 also has access to the SP's database 6 with historical information concerning the customer's operation as well as all technical specification data of the electrodes in the electric arc furnace. In this context it is possible to trouble-shoot and find an immediate solution to a problem, it is possible to generate a report that addresses and diagnoses the specific problem, and to provide technical information that would not otherwise be available to the customer.

The invention thus described utilizes recent technological developments and capabilities for a cost effective system that allows a supplier to increase a level of support to his clients. At the same time, the costs associated with the value added service is relatively small or the improved efficiency even compensates for the service.

1. A product support method in a business relationship between a supplier and a consumer, wherein the supplier supplies products to the consumer and the consumer uses the products in an industrial process, the method which comprises:
under control of a system established at the consumer's location:
monitoring the industrial process and acquiring items of performance information concerning the products used in the industrial process;
storing data with the items of performance information in a memory device;
under control of the system established at the consumer's location or a system established at the supplier's location:
initiating a connection and transferring data with the performance information from the memory device to a database maintained at the supplier's location;
under control of the system established at the supplier's location:
processing the data and generating a report concerning the consumer's industrial process and the performance of the products in the industrial process.

2. The method according to claim 1, wherein the products are wear items and the performance information includes information about a rate of wear of the products.

3. The method according to claim 2, wherein the step of generating a report comprises predicting when a supply of products will be exhausted by the consumer and prompting the consumer for a delivery order or initiating a further delivery of products.

4. The method according to claim 1, wherein the industrial process is a smelting process with an electric arc furnace and the products are electrodes, and the monitoring step comprises measuring and recording a voltage at the electrodes and a current consumed by the electrical arc furnace.

5. The method according to claim 4, which comprises recording real-time data and storing the real-time data spanning a given time period in the memory device, and pre-processing the real-time data by averaging the data over extended time periods.

6. The method according to claim 5, which comprises setting the given time period to between 1 and 10 hours and transferring the data from the consumer's location to the supplier's location approximately once a day.

7. The method according to claim 1, wherein the consumer is one of a plurality of consumers commonly connected to the supplier, and wherein the data processing step comprise establishing comparative information and benchmarking data for use by each of the plurality of consumers.

8. The method according to claim 1, wherein the industrial process is an electrolysis process with electrolysis cells, and the products are cathode blocks, and the monitoring step comprises repeatedly checking the cathode blocks for a degree of erosion requiring imminent replacement.

9. The method according to claim 1, wherein the industrial process is a blast furnace process and the products are furnace lining blocks, and the monitoring step comprises repeatedly checking the furnace lining blocks for a degree of erosion requiring imminent replacement.

10. In a business relationship between a supplier and a consumer, wherein the supplier supplies products to the consumer and the consumer uses the products in an industrial process, a product support method, which comprises:
under control of a system established at the consumer's location:
monitoring the industrial process and acquiring items of performance information concerning the products being used in the industrial process;
storing data with the items of performance information in a memory device;
upon detecting abnormal or catastrophic behavior in the industrial process, initiating a trouble-shooting session by reporting the abnormal or catastrophic behavior to the supplier;
under control of the consumer or under control of the supplier:
initiating a connection and downloading data with the performance information from the memory device;
under control of the supplier:
processing the data and generating a report concerning the consumer's industrial process and the performance of the products in the industrial process.

11. The method according to claim 10, wherein the industrial process is a smelting process with an electric arc furnace and the products are electrodes, the monitoring step comprises measuring and recording a voltage at the electrodes and a current consumed by the electrical arc furnace.

12. The method according to claim 11, which comprises recording real-time data and storing the real-time data spanning a given time period in the memory device, and wherein the processing step comprises processing the real-time data.
